(19) United States
(12) Patent Application Publication
(10) Pub. No.: US 2005/0264263 A1
(43) Pub. Date: Dec. 1, 2005

(54) Methods of charging, equalizing, and controlling Li-based batteries

(76) Inventor: Boris I. Tsenter, Roswell, GA (US)

Correspondence Address: BORIS TSENTER, 1985 GLENEVES DRIVE, ROSWELL, GA, 30076, US

(21) Appl. No.: 10/709,831

(22) Filed: Jun. 1, 2004

(51) Int. Cl. H02J 7/00

(52) U.S. Cl. 320/128

(57) ABSTRACT

Method of charging Li-based battery involves keeping the right balance among battery voltage, ohmic resistance, and charging current. Invention offers battery overvoltage protection value as the difference between the maximum voltage and the instantaneous open-circuit voltage. Overvoltage protection is supported when the minimum charging current is set as the ratio between difference in battery terminal voltage and instantaneous open-circuit voltage, and ohmic resistance. Method of equalizing Li-based battery is based on stabilization of cell voltage at end-of-charge by connecting in parallel to each cell, three series-connected Ni-based (i.e., NiCd or NiMH) cells, which serve as voltage stabilizers at end-of-charge. Individual lithium cell (flying cell) periodically connected to battery cells in process of charging and (or) discharging is used for equalizing of lithium battery cells. Method of controlling Li-based battery is based on measurement of battery ohmic and chemical resistances, and open-circuit voltage, with and without current interruption. Ohmic resistance controls the battery charging process and battery state-of-health. Nonstationary open-circuit voltage is used as an indicator (fuel gauge) of battery state-of-charge. Electrical double layer capacity provides information regarding electrode surface.

### TECHNICAL FIELD

This invention relates to methods of charging, equalizing and controlling Li-based batteries used in electric vehicle (EV), hybrid EV, and automatic EV, applications; mobile phones; two-way radios; handheld and notebook computing devices; commercial and portable industrial devices; etc.

### BACKGROUND ART

Various methods of charging Li-based (ie, Li-ion, Li polymer, and metallic Li) batteries exist. All those methods require that the battery terminal voltage be kept below maximum level during charging. That level is variable and ranges, as a rule, between 4.0 and 4.2 V. Low maximum voltage promotes long cycle life at the expense of single-discharge-period capacity. Exceeding maximum voltage causes irreversible damage associated with electrolyte decomposition, electrodeposition of metallic lithium, or oxidation of the positive electrode current collector. These processes adversely affect battery cycle life and, more dramatically, cell integrity in case of intensive gassing.

Typical charging method is constant current (CC) charging to a maximum voltage, then constant voltage (CV) charging until the charging current reaches preselected minimum (CM) value. Requirements of this method are not specified. Voltage precision that should be supported in CV charging mode is not clear. The CM value, which, as a rule, is the C/10 rate is chosen without firm ground. This invention describes a method of battery charging which sets the charging parameters for CV and CM charging, based on specific battery parameters such as ohmic resistance, chemical resistance, and nonstationary open-circuit voltage (OCV).

Approaches that use battery ohmic resistance for calculating optimum charging voltage is known in the art. Patino, et al (U.S. Pat. No. 5,969,508) proposed to keep optimum charging voltage as sum of battery maximum voltage and product of battery impedance and current. Battery impedance data is stored in EPROM. Parts of battery impedance that are considered are not clear: ohmic part (correct) or impedance as sum of ohmic and chemical resistances. Battery resistance is subject to gradual change especially when charging with high current and at voltage on the edge of electrolyte decomposition. Therefore, a dynamically sampled value of battery ohmic resistance should be used.

Li-based battery, in comparison to Ni-based batteries, don't have capability to be overcharged without damage. While the rate of self discharge of individual cells is different within a battery string, lithium cells are subject to equalization (balancing). Lithium battery equalization is taught in two sources (U.S. Pat. No. 6,653,820 and U.S. Pat. No. 6,586,915). One approach uses a shuffling transformer or a capacitor to take capacity from a lithium cell of high voltage (and transferable energy) to a cell of lower voltage. The other approach uses a shunt regulator and a power source to provide a charging current to a cell. The input voltage from the power source is limited by the first feedback control loop to ensure that the input voltage does not exceed the breakdown voltage of the shunt regulator. The output voltage from the shunt regulator is limited by the second feedback control loop to ensure that the output voltage does not exceed the maximum rated voltage of the battery. The drawback of these methods is high cost of electronic equipment, in case of shuffling devices, long equalization time. The simplest way to equalize lithium cells is to employ resistance and power switcher to regulate discharging power. Trade offs exist between rate of equalization and cost of parts. The incremental parts cost consists not only of switchers themselves, but also of cooling system. No efficient method of lithium cell equalization, especially in case of high capacity (tens of ampere hours) and long string, multicell battery, exist.

Lithium-based battery is a very conservative electrochemical system which doesn't offer many parameters to control in stationary charging or discharging processes. One approach to overcome this limitation is to obtain information regarding battery mode in transient processes that correspond to current switching or interruption. Information associated with this approach is limited. Sakai, et al (U.S. Pat. No. 6,608,482) teaches battery control method for hybrid vehicle with determination of battery state-of-charge based on battery OCV calculated from battery impedance. Nor (U.S. Pat. No. 5,729,335) describes procedure for measuring ohmic resistance-free voltage, which is battery voltage minus product of ohmic resistance and current. Tsenter (U.S. Pat. No. 5,729,116) teaches the procedure for recognizing hard, soft, and chemical shunts by monitoring battery OCV and chemical polarization with current interruption.

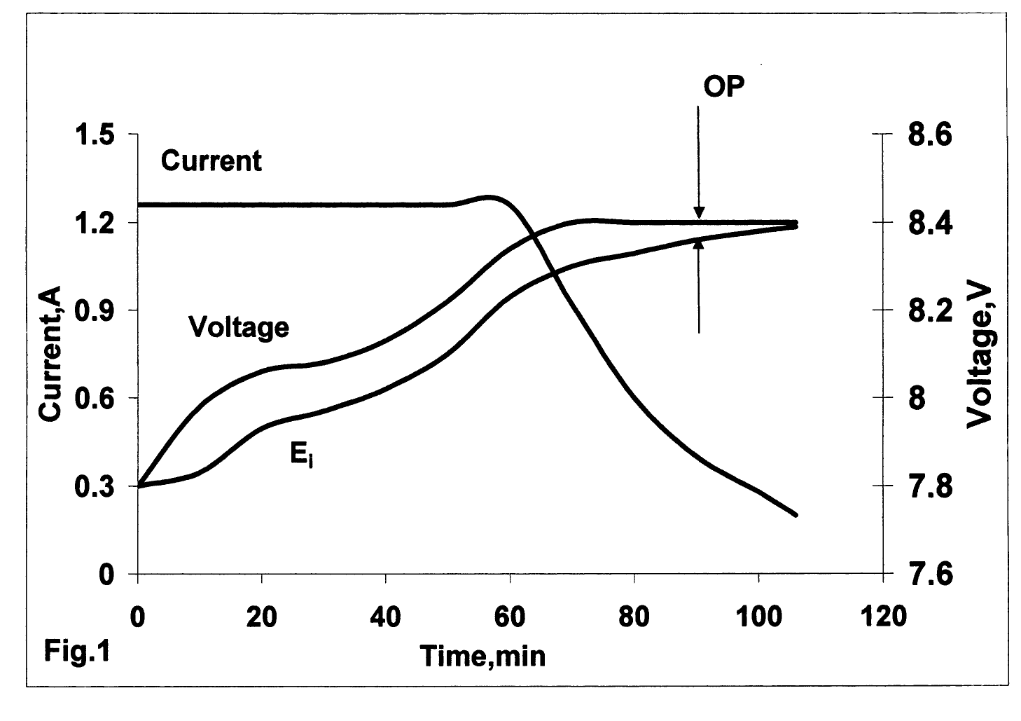

FIG. 1 illustrates relationship between battery terminal voltage and instantaneous OCV in process of charging Li-based battery.

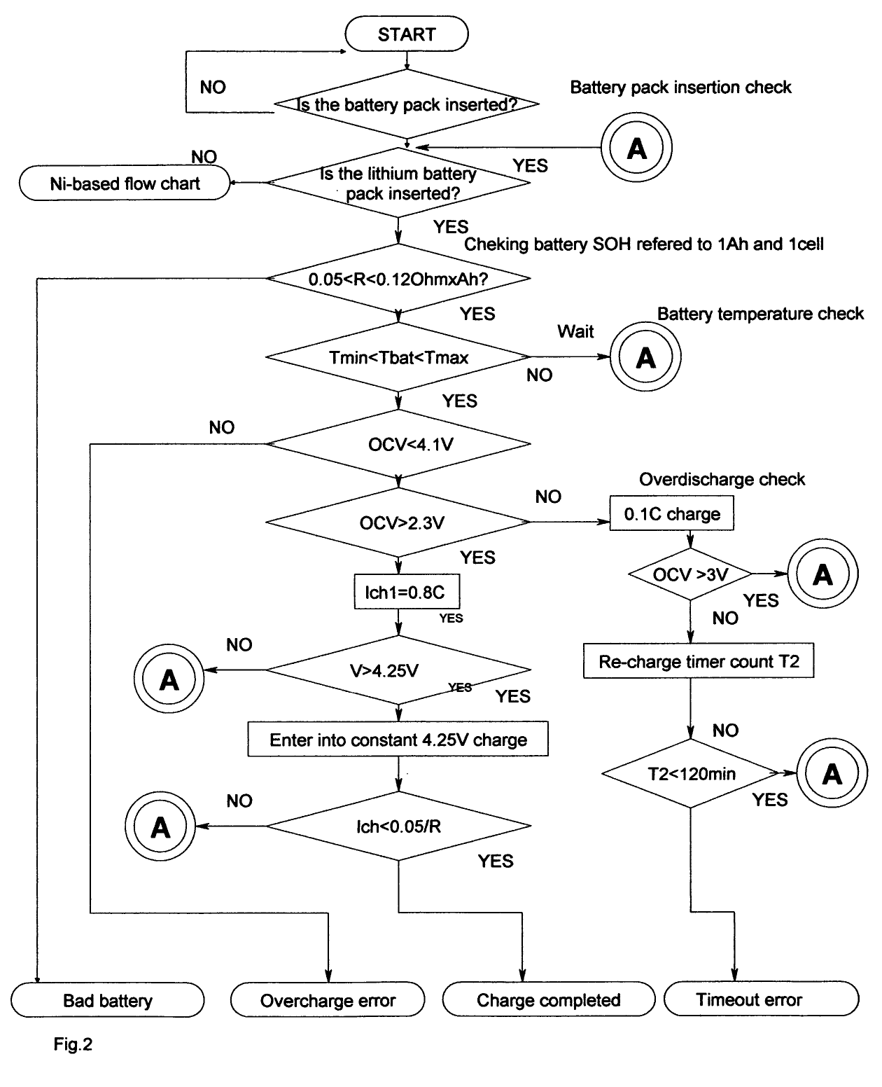

FIG. 2 illustrates flowchart for charging Li-based battery.

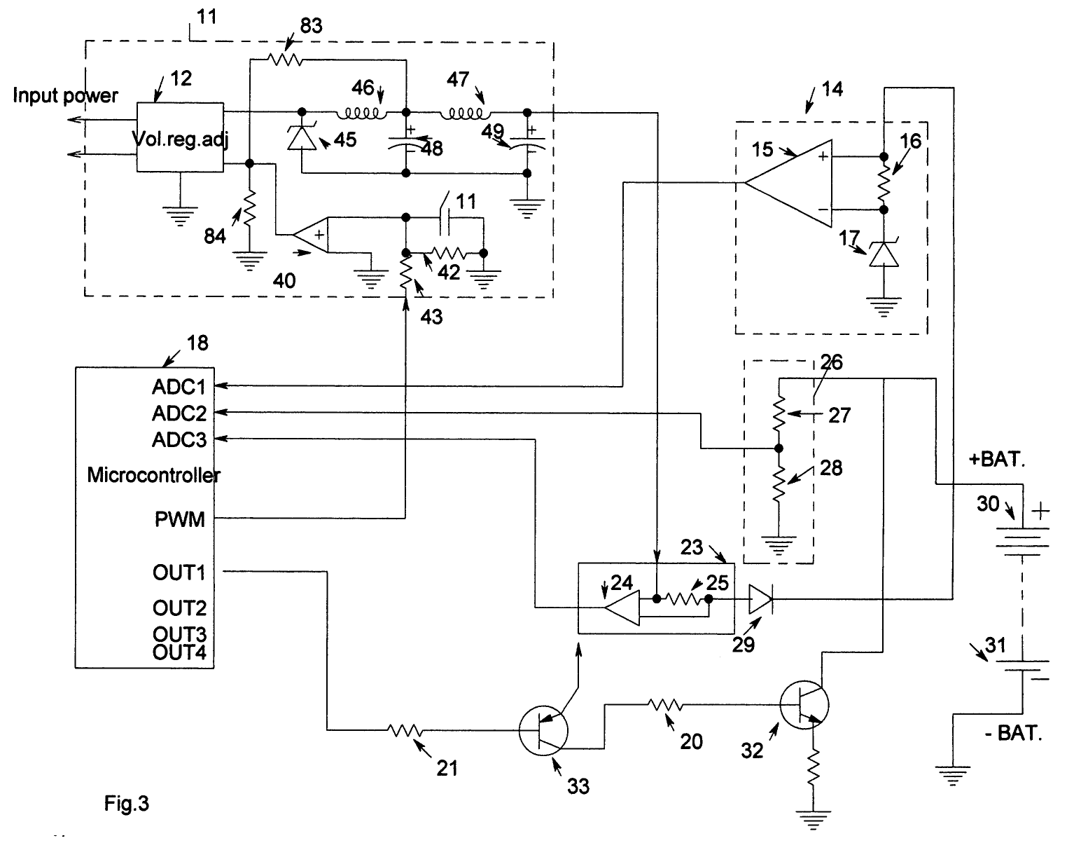

FIG. 3 illustrates charger schematic for battery charging.

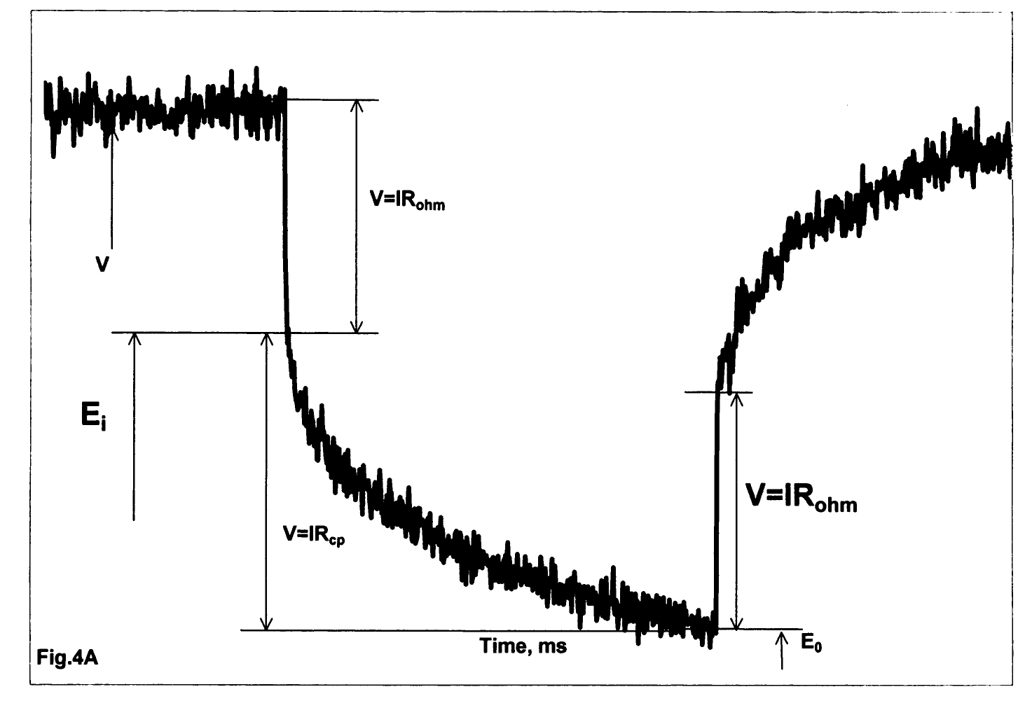

FIG. 4 illustrates single-pulse profile and procedure for measuring battery OCV, and ohmic and chemical resistances with (A) and without (B) current interruption.

Battery Charging Method

Proposed methods of charging Li-based battery are based on a balanced cell voltage during charging. It is the sum of reversible open-circuit voltage, E₀, negative, (ₐ, and positive, (_{c}, electrode polarizations, and product of cell ohmic resistance and current:
V=E₀+((a+(c)+IRₒₕₘ (1)

Electrode (or chemical) polarization (CP) includes polarization associated with charge (or activation) polarization and mass transfer (or concentration) polarization.

While E₀ is the difference of reversible electrode potentials, the sum of E₀, (ₐ, and (_{c} gives the difference in electrode potential of cell during charging:
Eᵢ=E₀+((ₐ+(_{c})=E₀+E_{CP} (2)

Where E_{CP}, the sum of (ₐ and (_{c}, is the chemical polarization and Eᵢ is the instantaneous open-circuit voltage, which stays intact immediately after current interruption when ohmic resistance disappears instantaneously. While chemical polarization relaxation time is hours long and current delay is hundreds-of-milliseconds long, E₀ in this case is considered nonstationary. We assume that thin negative and positive electrodes can be considered as smooth electrodes. In this case the difference in electrode potentials affects chemical situation on interfaces between electrodes and electrolyte during charging. The difference in electrode potentials is responsible for electrolyte decomposition, current conductor corrosion, rate of charge, and Li⁺ ion transfer rate. Therefore, if Eᵢ is kept lower than or equal to maximum voltage, lithium cell will retain chemical integrity. Based on Eq. 1 and 2, the difference between terminal voltage, V, and Eᵢ exactly equals the product of ohmic resistance and charging current (See FIG. 1). Voltage in the regular charging procedure should be Eᵢ, plus the product of I and Rₒₕₘ:
V=Eᵢ+IRₒₕₘ (3)

The product, IRₒₕₘ, serves as means for overvoltage protection. As soon as the current is diminished at end-of-charge, the voltage approaches Eᵢ. This invention offers proper choice of overvoltage protection (OP) level that can be specified as the difference between maximum voltage and Eᵢ (FIG. 1). If maximum voltage equals constant voltage as in regular CC-CV-CM charging method, the overvoltage protection equals IRₒₕₘ per Eq. 3. Minimum overvoltage protection coincides with maximum value of Eᵢ. Minimum overvoltage protection in regular charging is 10-30 mV for a new Li-ion consumer battery. Indeed, minimum ohmic resistance normalized to 1 Ah equals 0.1 ΩAh per cell. Minimum charging current therefore corresponds to the 0.1 C rate. The product of ohmic resistance and minimum current is 10 mV. For this value, maximum voltage, Vₘₐₓ, exceeds Eᵢ at end-of-charge, and minimum overvoltage protection is provided. At that point Eᵢ gets maximum value. For any other current greater than CM, battery will be better protected. For a given OP, CM value, Iₘᵢₙ, is specified as ratio of difference between Vₘₐₓ and Eᵢ to Rₒₕₘ:
Iₘᵢₙ=(Vₘₐₓ−Eᵢ)/Rₒₕₘ (4)

This CM provides battery overvoltage protection for given ohmic resistance Rₒₕₘ. Based on Eq. 4, battery ohmic resistance has to be recognized in order to keep proper minimum charging current for given battery protection level. Based on Eq. 3, we can state that battery terminal voltage can exceed maximum voltage if it equals IRₒₕₘ. That means battery can be charged fast when V_{CV} is more than Vₘₐₓ (4.2 V), if product of charging current and ohmic resistance provides overvolage protection per Eq. 3. In other words, payment for fast charging under high terminal constant voltage is high CM (sometimes lower charging capacity) to protect battery.

In accordance with the present invention, FIG. 3 illustrates a schematic circuit diagram for the preferred embodiment of the invention. Battery charger comprises the necessary elements for achieving the methodology described herein, and includes a power manager 11 connected to a power supply (not shown). Microcontroller 18 controls the power manager 11, and receives information through a first voltage feed back circuit 14 and a second voltage feedback circuit 26, and from current feedback circuit 23. Microcontroller 18 typically comprises analog/digital converters ADC1, ADC2, and ADC3; software- or hardware-based pulse width modulator (PWM); input/output (I/O) ports OUT1, OUT2, OUT3, and OUT4; read only memory; and timers. Output voltage is controlled by microcontroller 18 and fed to power manager 11. The output control voltage is filtered through resistors 42 and 43, and capacitor 41, and fed through operational amplifier 40 to the power manager 11. This voltage at the output of operational amplifier 40, first resistor 83, second resistor 84, and adjustable voltage regulator 12, sets the voltage at diode 45. Inductors 46 and 47, capacitors 48 and 49, and diode 45 are used to filter the voltage. Current feedback is derived by measuring the voltage across shunt 25 with operational amplifier 24. Diode 29 prevents voltage of rechargeable lithium battery 10 from being fed back to the charger. Voltage feedback from first cell 30 is provided by voltage feedback circuit 14 comprising shunt 16, zener diode 17, and operational amplifier 15. Since zener diode 17 is used, feedback voltage from first cell 30 will not be full scale (i.e., zero to the battery's maximum voltage), but will be at scale of the zener diode 17's voltage to the battery's maximum voltage. Voltage feedback from first cell 30 is provided by voltage feedback circuit 26 comprising resistors 27 and 28 and forming a voltage divider. Transistors 30 and 31 equalize batteries cells 32 and 33. Transistors 32 and 33 are controlled by microcontroller 18. Lights 19 and 21 display charging status. Resistors 20 and 22 limit the current to lights 19 and 21. A temperature detector or sensor (not shown) may be utilized to measure temperature T of battery 10. Although not critical to the present invention, the temperature detector may be useful as a default safety mechanism to prevent explosive reactions from taking place. The collected information is fed to microcontroller 18, which can in turn signals adjustment or termination of the charging current of power manager 11. The microcontroller 18 is used to run and monitor the operation of the battery charger and to compile and analyze the instantenious open-circuit voltage or charging voltage depending on charging algorithm. Its second function is to detect minimum charging current and preselected charging time for charge termination. Microprocessor 18 also calculates ohmic and chemical polarizations, electrode surface, SoC, and SoH, based on algorithms disclosed in this invention. Battery charger is precise enough to measure open-circuit voltage within 1 to 10 ms of charge interruption to thereby obtain information regarding ohmic polarization and instantaneous OCV. Measurement of OCV vs time inside 10 to 15 ms allows one to obtain electrode electrical double layer capacity. Measurement by microcontroller of OCV inside 10 to 180 ms gives information regarding chemical polarization, battery unstationary OCV, and SoC.

Invention offers several charging mode options:
a. CC-CEᵢ-CM Charging.

Battery is charged with constant current up to Eᵢ, where Eᵢ is supported at the Vₘₐₓ level. Battery voltage is changeable and free in this case and differs from Eᵢ by magnitude equal to IRₒₕₘ. Battery is charged without overvoltage protection for battery cell, while product of IRₒₕₘ is not a protective factor. Some protection comes from electronic circuitry, which supports Eᵢ at the level of: Eᵢ=4.2 V−ΔEᵢ. A battery charges initially at constant current until Eᵢ reaches Vₘₐₓ and Eᵢ is recognized by current interruption. Another way to find Eᵢ is to recognize and subtract IRₒₕₘ from V. Charge is terminated when minimum current reaches the preselected value. Advantage of this method is its capability to provide battery with maximum capacity in the shortest time. Another advantage is measurement of Eᵢ in a current less period that provides precise measurement. Keeping battery at the edge of electrolyte decomposition and supporting Eᵢ with high precision are disadvantages of this approach.

FIG. 1 illustrates relationship between current, terminal voltage, and E during charging.
b. CC-CV-CM Charging.

CV is supported at the level of Vₘₐₓ plus IₘᵢₙRₒₕₘ. While charge is cutting off at current Iₘᵢₙ, Eᵢ never exceeds 4.2 V, eliminating threat of electrolyte decomposition. Certainly, if battery has its own protection circuitry, the 4.2 V+IₘᵢₙRₒₕₘ voltage has to be less than minimum protective voltage in order to avoid premature charge termination. Setting minimum current value depends on how much constant voltage level exceeds maximum voltage. If maximum voltage is set at 4.2 V, and constant voltage is set at V, minimum current, from Eq 4, is: Iₘᵢₙ=(V−4.2 V)/Rₒₕₘ.

If minimum current is set at 0.4 C rate and R is 0.13 ΩAh per cell, for example, constant voltage value is 4.25 V. Charging is started with constant current at the 0.6-0.8 C rate. As soon as voltage reaches 4.25 V battery stays at this voltage until current drops to 0.4 C rate. Battery has overvoltage protection during most of charging until end-of-charge, where OP is close to zero. Voltage should be supported with precision of ±−10/−15) mV.
c. CC-CVₘₐₓ-CM Charging.

It is constant current (CC), constant voltage (Vₘₐₓ), minimum current (CM) regular charging. If Vₘₐₓ is set at 4.2 V, and minimum current equals 0.1 C rate, OPₘᵢₙ is: 0.13·0.1=13 mV. The accuracy of supporting maximum voltage should be the same, +13 mV. At any other point of charging, battery is better protected while charging current exceeds Iₘᵢₙ. If battery ohmic resistance rises during cycling, minimum current can be dropped in order to keep IRₒₕₘ equal to OPₘᵢₙ. This mode increases charging time but also increases charging capacity. FIG. 2 is flow chart for charging Li-based battery with changeable CM depending on battery ohm resistance.

Table 1 illustrates specifics of different charging methods

| Charging | | | | |
|---|---|---|---|---|
| Mode | | | | |
| Option | | | | |
| Mode | Voltage | Current | Advantage | Disadvantage |
| CC-CEᵢ- | Flexible in | Constant | Fast | High accuracy in |
| CM | order to keep | until | charging | supporting E₁, |
| | Eᵢ constant | reaching E₁ | | low OP level |
| CC-CV- | Constant | Constant | Moderate | High accuracy in |
| CM | after | until | charging | supporting V |
| | reaching | reaching | rate | |
| | Vₘₐₓ + IₘᵢₙR | Vₘₐₓ + IₘᵢₙR | | |
| CC- | Constant, | Constant | High level | Slow charging |
| CVₘₐₓ-CM | after | until | of OP | |
| | reaching | reaching | | |
| | Vₘₐₓ | Vₘₐₓ | | |

Test results:

Panasonic CGR1850HG (1.8-Ah Li-ion battery) is charged in CC-CEᵢ-CM mode with Eᵢ equal to 4.2 V. Charging time is 64 minutes in comparison to 84 minutes using CC, 1 C; CV, 4.2 V; and CM, 0.1 C mode. Delivered capacity is the same in both cases and equal to 98% of rated capacity.

Panasonic CGR1850A (2-Ah Li-ion battery) with ohmic resistance of 0.13 ΩAh is charged in CC-CV-CM mode. The CV is set at 4.25 V (mode b). CM is (4.25 V-4.2 V)/0.13 ΩAh/2 Ah=0.76 A (0.4 C rate). Initial CC value is set depending on how fast battery has to be charged. Initial current is not limited with respect to electrolyte decomposition, but can affect cycle life by influencing structure of positive electrode through rate of crystal lattice compression or heat production. In our test under CC at the 1 C rate, battery delivered 95% rated capacity after 72 minutes of charging time. Under regular (CC, 0.7 C; CV, 4.2 V; and CM, 0.1 C) charging, 98% of rated capacity is achieved after 107 minutes of charging.

Panasonic CGR1850HG (1.8-Ah Li-ion battery) has protected circuitry with switch-off voltage of 4.3 V+/−0.05 V. The minimum protected voltage from battery circuitry is 4.25 V. If this voltage is set as constant voltage (CV) in CC-CV-CM charging procedure where CC is 1 C rate, CM=(4.25 V−4.2V/0.13 ΩAh/1.8 Ah=0.7 A (or 0.4 C rate) emerges after 58 minutes of charging. Discharge capacity is 92% of rated capacity compared with 95% achieved after 109 minutes of regular charge (CC, 0.7 C; CV, 4.2 V; and CM, 0.1 C). After charging with CC at 1 C rate and CV at 4.2 V for 58 minutes, battery delivers only 85% of rated capacity.

This example illustrates practicality of proposed approach; battery can be charged faster with delivering of the same capacity or delivering more capacity under the same charging time as in regular CC-CV-CM mode. Charging in regular mode becomes more intelligent by changing CM per battery Rₒₕₘ value according this invention. User has choice between charging time, delivered capacity, and battery cycle life.

Cell Balancing (Equalization) Method

Proposed method of cell balancing is based on supplying each lithium cell with electrochemical voltage stabilizer. Voltage stabilizer uses three series-connected Ni-based cells with rated capacity C_{Ni}. Each cell being overcharged at the 0.15-0.1 C_{Ni} rate has stationary charging voltage around 1.4 V at 20° C. Three cells in series produce 4.2 V. As soon as a lithium cell's voltage is below 4.2 V, almost all charge flows to that cell. When a lithium cell reaches 4.2 V and charging current is at 0.15-0.1 C_{Ni} rate, three series-connected Ni-based (NiCd or NiMH) cells work as voltage stabilizer that shunts lithium cell. Lithium cell stays under constant voltage for predetermined time while equalization process is in progress: lithium cells with lower capacity (voltage) get more charge. If capacity of Ni-based cells makes up 10% of lithium cell capacity, final equalization current must equal 0.015-0.01 C_{Li}. Problem is indication that transient charging voltage is high for Ni-based chemistry. It can be overcome by design correction and/or correction of operating conditions. Lithium hydroxide electrolyte component can be eliminated or decreased, for example, since it is responsible for higher overvoltage of oxygen production. In that case, early oxygen production results in decreasing the maximum transient charging voltage. Supporting Ni-based cells at higher than ambient temperature is example of operating condition effect. High temperature decreases peak charging voltage of Ni-based cells. Charging Li-based battery in CC-CEᵢ-CM or CC-CV-CM mode at voltage greater than 4.2 V proposed in this invention, also alleviates problem of high transient voltage for Ni-based batteries.

The Ni-based cell string can be permanently connected to a lithium cell or it can be part of charging system. In this case, a three-cell string from the Ni-based battery of the charger is connected to one lithium cell. If Ni-based cells are connected permanently to a lithium cell, the resulting battery can be considered as a hybrid power source, which combines high energy of lithium cell, and high power and overcharging capability of Ni-based cells. Ni-based cells provide voltage stabilization during overcharging on the one hand (lithium cell balancing) and boost power during discharging of a hybrid power source.

The charging algorithm of a hybrid lithium cell can be by constant current, then constant voltage up to certain period of time until current reaches stationary value. It means that lithium cells are in balancing mode

There is other approach for equalizing lithium cells. It is employment of individual lithium cell (“flying” cell) as equalizing element. Flying lithium cell has capability to be connected to all batteries cells by means of switches. It should be n+5 switches in case of employment one flying cell for n battery cells. Under battery discharging flying cell is connected to lithium battery cell, which has minimum discharging voltage. As soon as voltage of two parallel connected cells (battery and flying cell) is getting equal to average battery cells voltage, flying lithium cell is disconnected from said lithium battery cell. Then flying lithium cell is connected to next battery cell, which has a minimum discharging voltage et cetera. Under charging flying cell is connected to battery cell having maximum charging voltage until voltage of two parallel connected cells is getting equal to average voltage of battery cells. After that flying cell is connected to the next battery cell with maximum voltage, equalize it and cetera. It can be different schedule of connecting battery cells and flying lithium cell depending on voltage distribution between battery cells. It can be different number of flying cell depending on number of battery cells.

Flying cell shouldn't have special charger, while get capacity in process of equalizing battery cells under charging.

Battery Control Method

The battery control method is based on the measurement of battery parameters to optimize charging process and to recognize battery state-of-health (SoH), cell imbalance level, etc. This information is obtained by measuring battery ohmic resistance, chemical polarization, and open-circuit.

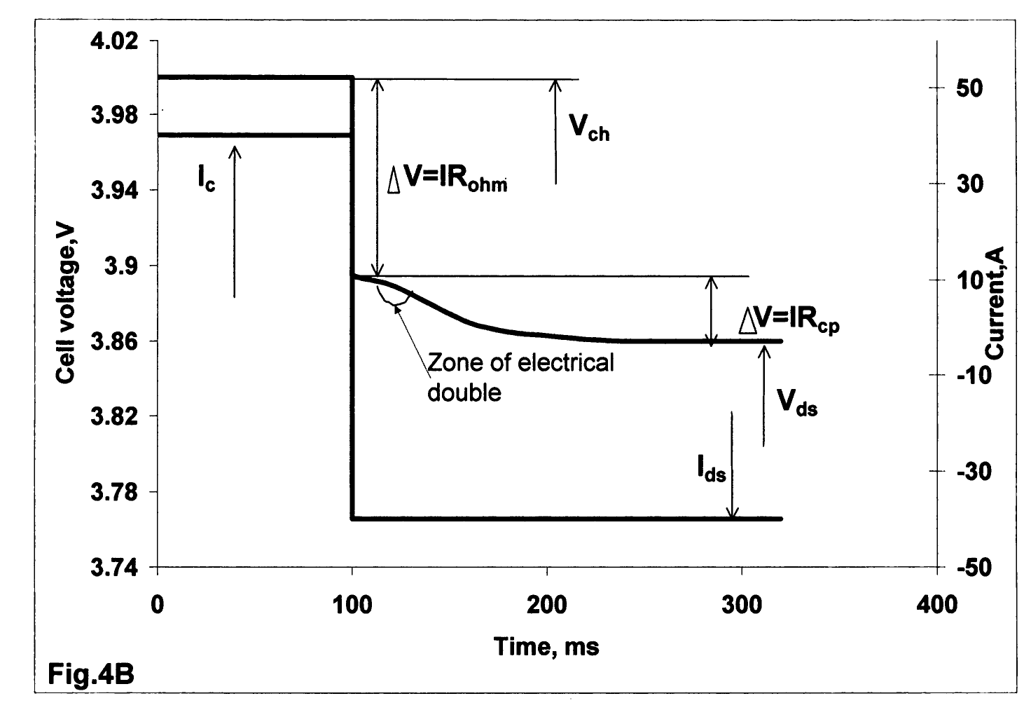

Ohmic resistance is measured during transient period of changing current (FIG. 5). Ratio of voltage difference to current difference is sampled at 1-to 10-ms intervals:
Rₒₕₘ=ΔV_{t<10 ms}/ΔI=(V₁−V₂)/(I₁−I₂) (5)

This approach is appropriate for applications where charging current cannotor should not be interrupted (e.g., spacecraft). In many applications charging current can be interrupted (I₂=0) and Rₒₕₘ is calculated using Eq. 3, as difference of terminal voltage and instantaneous OCV divided by current. Ohmic resistance, Rₒₕₘ, is normalized to 1 Ah capacity and has units, ΩAh. Because Rₒₕₘ is almost independent of battery state-of-charge and temperature, it can be used to “qualify” battery. A Li-ion cylindrical-cell battery, for example, is “qualified” (healthy) with respect to SoH if its ohmic resistance, Rₒₕₘ, is between 0.07 and 0.18 ΩAh. Higher Rₒₕₘ-value indicates problem with battery power and lower value indicates high probability of battery shunting.

For prismatic cell battery, ohmic resistance for healthy battery is in range of 0.16 to 0.24 ΩAh (Table 2).

Along with SoH measurement, information concerning ohmic resistance gives Eᵢ as difference between voltage and product of ohmic resistance and current. The Eᵢ value is used to support Eᵢ in CC-CEᵢ—CM charging mode.

TABLE 2
Ohmic Resistances of Li-ion Batteries at Full Charge or Discharge

| | | | Resistance, |
|---|---|---|---|
| | Battery | Ohm | ΩAh |
| Battery | Temperature, ° C. | Charge | Discharge |
| MoliCell ICR18650C, | 25 | 0.13 | 0.15 |
| cylindrical, 2000 mAh | | | |
| Panasonic CGR18650HG, | 24 | 0.11 | 0.14 |
| cylindrical, 1800 mAh | | | |
| Panasonic CGR18650A, | 23 | 0.12 | 0.16 |
| cylindrical, 2000 mAh | | | |
| Sanyo 4F1034505, prismatic, | 23 | 0.16 | 0.24 |
| 1400 mAh | | | |

Information regarding ohmic resistance allows adjustment in V and Iₘᵢₙ in CC-CV-CM charging mode.

Electrochemical kinetics of lithium-metal oxide cell chemistry is linear: electrode potential linearity depends on current in given current range. Based on that, chemical polarization can be sampled without current interruption by measuring voltage drop for interval between first appearance of chemical polarization (10 ms) and its disappearance (interval of 150 to 500 ms). Chemical resistance follows:
R_{ch}=ΔV/ΔI=(V_{<10 ms}−V_{>150 ms})/(I₁−I₂) (6)

If current is interrupted completely, chemical resistance is measured as differences between charging voltage, ohmic polarization and nonstationary OCV divided by charging current or as instantaneous OCV minus nonstationary OCV divided by current
R_{ch}=(V−RₒₕₘI−E₀)/I=(E₀−E₀)/I (7)

Eq. 7 is a special case of Eq. 6.

Information about chemical resistance allows to recognition of nonstationary OCV and dynamic battery state-of-charge per OCV value. For charging current I, open-circuit voltage, from Eq. 1, is
E₀=V−I(Rₒₕₘ+R_{ch}) (8)

OCV can be recognized at any time without current interruption from any given I, Rₒₕₘ, and R_{ch}.

FIG. 4A illustrates measurement procedure in situation when current is interrupted. Transient time is considered when battery switches from charging to discharging (e.g., space application). FIG. 4B illustrates measurement procedure in case of current is not interrupted.

The time period between current interruptions (pulse frequency) may last from seconds up to minutes depending on charging rate and battery capacity. Instantaneous battery open-circuit voltage Eᵢ is sampled after 1 to 5 ms of current interruption. The given Eᵢ is exactly monitored lithium and metal oxide electrode potential difference while ohmic resistance (which doesn't have inertia) disappears. The electrodes polarization (overvoltage) is still intact. Battery chemical polarization, the sum (ₐ+(_{c}, is obtained as the OCV difference 10 ms prior to and after 200 ms after current interruption or current switching. The sum of two chemical polarizations divided by current yields chemical resistance. Chemical polarization at given current depends on exchange current, state-of-surface, and temperature. At end of charge, the sum (ₐ+(_{c}, depends also on Li⁺ ion transfer rate. Measurement of chemical polarization provides additional valuable information especially regarding electrical double layer capacity and through that regarding electrode surface. Indeed by sampling two transient OCV values associated with chemical polarization at initial appearance of chemical polarization, double layer capacity can be expressed as:
C═IΔt/ΔE_{CP} (9)

Where Δt is time difference, for example, 3 ms; ΔE_{CP} is difference in OCV at 12 and 15 ms after interruption of charging current. The same result can be obtained without current interruption by measuring voltage change due to current change. Double layer capacity reflects sum of the two series-connected capacitors of positive and negative electrodes.

1. Method of charging li-based batteries by constant current and then by constant voltage to minimum current, with following operations:
a. Measurement of battery ohmic resistance
b. Setting of battery overvoltage protection value, and
c. Setting of minimum charging current depending on battery ohmic resistance and overvoltage protection.

2. Method of charging Li-based battery of claim 1, wherein said overvoltage protection is specified as difference between maximum voltage and instantaneous open-circuit voltage at battery terminals after 1 to 10 ms of current change.

3. Method of charging Li-based battery of claim 1, wherein said minimum charging current is chosen as ratio of minimum overvoltage protection to battery ohmic resistance

4. Method of charging Li-based battery of claims 1-3, wherein maximum voltage, Vₘₐₓ, ranges between 4.0 and 4.2 V per cell.

5. Method of charging Li-based battery of claim 1, wherein constant voltage is instantaneous open-circuit voltage.

6. Method of charging Li-based battery of claim 1, wherein constant voltage equals maximum voltage.

7. Method of charging Li-based battery of claim 1, wherein constant voltage equals maximum voltage plus product of minimum charging current and ohmic resistance.

8. Method of charging Li-based battery of claim 1, wherein minimum overvoltage protection is 0 to 50 mV.

9. Method of charging Li-based battery of claim 1, wherein tolerance of supporting constant voltage has to be less than minimum ovevoltage protection.

10. Method of charging Li-based batteries of claims 1, wherein the minimum charging current reaches 0.6-0.05 C rate.

11. Method of Li-based battery equalization in process of battery discharging, wherein individual lithium cell is periodically connected to battery lithium cell having minimum discharging voltage until voltage of two cells is getting equal to dynamically preselected voltage.

12. Method of Li-based battery equalization in process of battery charging, wherein individual lithium cell is periodically connected to battery lithium cell having maximum charging voltage until voltage of two cells is getting equal to dynamically preselected voltage.

13. Method of Li-based battery equalization, wherein three series-connected Ni-based batteries are connected in parallel to each Li-based cell, and Ni-based cells are part of charging device.

14. Method of hybridizing lithium battery and creating one hybrid power source, wherein each lithium cell permanently contains three series-connected Ni-based cells, wherein Li-based cell and Ni-based cells have parallel connection.

15. Method of charging Li-based battery of claims 11 and 12 by constant current, and constant voltage, wherein charging is interrupted when charging current reaches stationary value.

16. Li-based battery control method that contains
a. Measurement of battery voltage
b. Measurement of ohmic resistance
c. Measurement of chemical resistance, and
d. Measurement of open-circuit voltage.

17. Battery control method of claim 14, wherein ohmic resistance is measured as ratio of two voltage differences corresponding to two current differences measured within 1- to 10-ms interval.

18. Battery control method of claim 15, wherein one of two currents is zero.

19. Battery control method of claim 14, wherein chemical resistance is measured as ratio of two voltage differences sampled prior to 10 ms and after 150-ms current change corresponding to two current differences.

20. Battery control method of claim 14, wherein one of two currents is zero.

21. Battery control method of claim 14, wherein nonstationary open-circuit voltage is defined as difference between terminal voltage and product of sum of ohmic and chemical resistances, and current.

22. Battery control method of claims 14 and 19, wherein nonstationary open-circuit voltage is used to recognize battery state-of-charge.

23. Battery control method of claim 14, wherein electrical double layer capacity is measured by sampling chemical polarization for 10 to 15 ms after current interruption, and obtaining ratio of product of current and time interval to chemical polarization difference for this time interval.

24. Method of charging and controlling Li-based battery of claims 1, 11, and 14 wherein said battery is Li-ion battery.

25. Method of charging and controlling Li-based battery of claims 1, 11, and 14, wherein said battery is Li polymer battery.

26. Method of charging and controlling Li-based battery of claims 1, 11, and 14, wherein said battery is metallic Li battery.
